(19) United States
(12) Patent Application Publication
(10) Pub. No.: US 2004/0061897 A1
(43) Pub. Date: Apr. 1, 2004

(54) Printing control method and printing control apparatus

(75) Inventor: Akiko Onishi, Tokyo (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 10/674,496

(22) Filed: Oct. 1, 2003

(30) Foreign Application Priority Data
Oct. 1, 2002 (JP) 2002-288881

(51) Int. Cl. G06K 1/00; G06F 15/00

(52) U.S. Cl. 358/1.15; 358/1.1; 358/1.18

(57) ABSTRACT

It is an object of the present invention to perform a print setting by a unit of page and reflect the print setting to printing. A setting table including an overall setting, which is applied to an entire one print job, and a partial setting, which is designated for each page based upon the overall setting, is stored in a table storage section. A data processing section refers to the setting table stored in the table storage section by a unit of one page for a metafile generated by a GDI. Then, if the page is a target of the partial setting, the data processing section converts the page into data of a format, which a printer can process, after reflecting a corresponding partial setting to it. The converted data is sent to the printer and printed.

### FIELD OF THE INVENTION

The present invention relates to a printing control method and a printing control apparatus which convert drawing data prepared in a host computer or the like into a predetermined format and output the drawing data to a printing apparatus.

### BACKGROUND OF THE INVENTION

Conventionally, in printing data prepared in various applications, a user opens a print dialog of an application to designate a printer to be used and execute printing. In that case, in a printer driver which is software for generating data in a data format used by the designated printer to perform processing (hereinafter referred to as print data), various print settings can be performed. For example, since processing to be performed in a process of generating print data is different between the case in which a photograph image is printed and the case in which text data is printed, the driver is required to apply image processing suitable for the respective cases. Therefore, it is preferable to select an image processing method corresponding to a type of object data to be printed. In addition, since an optimum image processing method, printing speed, and the like are also different between the case in which an image is printed on a plain paper and the case in which an image is printed on a photo-paper for printing a photograph, it is necessary to select a suitable sheet in order to perform printing suitable for a sheet to be used.

In addition, in a printer provided with functions, for example, a print layout such as a size and an orientation, and N-up printing for arranging a plurality of pages on data prepared in an application (hereinafter referred to as a logical page) with respect to one side of a sheet to have an image printed thereon (hereinafter referred to a physical page), magnification/reduction print setting for magnifying/reducing to output an image, and duplex printing for printing images on both sides of a sheet, it is possible to designate items concerning a layout such as a duplex print setting, a sheet size, and the like.

Besides, it is also possible to perform a stamp setting for adding a stamp such as “for internal use only” in printing a document and a setting of special effects or the like in printing a photograph.

With the printer driver, a user interface (UI) screen is displayed and these print settings are performed on the screen, whereby various data can be printed in an optimum state in accordance with the designated print settings.

Since these print settings of the printer driver are performed by a unit of print job, a common print setting is applied to an entire print target in one print job.

However, in printing document data extending over a plurality of pages, it is also possible that a user wishes to set a layout. For example, the user may wish to perform duplex printing for pages including only a text and perform simplex printing for pages including images or performing 2-up printing for a part of pages. In addition, it is also possible that a user wishes to change a print quality in the middle of a job. For example, the user may wish to print pages including only a text giving priority to a speed and print pages including graphics with a print quality increased.

In this way, in the case in which it is attempted to change a print setting in the middle of a document, a manipulation for printing up to a page, for which the setting is required to be changed, once, activating a print job again, and printing remaining pages after changing the print setting is required.

As a technique of changing an image processing method in the middle of a job, there is known a technique of automatically changing a method of image processing according to contents forming a pages such as performing gray scale printing for pages including only a text and performing color printing (graphics printing) for pages including graphics. However, with this technique, the image processing method is simply changed according to circumstances, and a layout of printing cannot be changed freely.

### SUMMARY OF THE INVENTION

The present invention has been devised in view of the above-described problems, and it is an object of the present invention to provide a printing control method and a printing control apparatus which make it possible to print a document, which is printed in one print job, in accordance with print settings designated for each page to thereby perform printing with a high degree of freedom with a simple manipulation.

In order to attain the above-described object, the present invention has a constitution as described below.

That is, a print control method of the present invention is a printing control method of converting data into print data which a printing apparatus can process, the printing control method including:

a setting step of setting an overall setting to be applied to the entire print data and a partial setting to be applied to a designated page in generating the print data; and

a conversion step of converting the data into the print data in accordance with the overall setting and the partial setting while preferentially applying the partial setting set by the setting step.

More preferably, the setting step has a page designation step of designating a page to which the partial setting is applied and, in the conversion step, the overall setting is applied to items other than items to which the partial setting is applied.

More preferably, the conversion step converts metadata generated by an operating system into the print data in accordance with the overall setting and the partial setting while preferentially applying the partial setting to the metadata.

More preferably, the conversion step converts bitmap data generated by a renderer into the print data in accordance with the overall setting and the partial setting while preferentially applying the partial setting to the bitmap data.

More preferably, the print data is bitmap data.

Alternatively, the present invention has a constitution as described below.

That is, a printing control method of the present invention is a printing control method of converting inputted drawing data into a print data which a printing apparatus can print and transferring the print data to the printing apparatus, the printing control method including:

a step of determining an overall setting which is a print setting to be applied to the entire drawing data;

a step of recording the overall setting determined in the entire setting determination step in a setting table for managing settings;

a step of determining a partial setting which is a setting to be applied only to a part of pages in the case in which the drawing data extends over a plurality of pages;

a step of recording the partial setting determined in the partial setting determination step in the setting table; and

a step of determining a setting to be used for each page of interest from the setting table and generating print data based upon the determined setting.

Alternatively, the present invention has a constitution as described below.

That is, a printing control apparatus of the present invention is a printing control apparatus for converting data into print data which a printing apparatus can process, the printing control apparatus including:

setting means which sets an overall setting to be applied to the entire print data and a partial setting to be applied to a designated page in generating the print data; and

conversion means which converts the data into the print data in accordance with the overall setting and the partial setting while preferentially applying the partial setting set by the setting means.

More preferably, the conversion means converts metadata generated by an operating system into the print data in accordance with the overall setting and the partial setting while preferentially applying the partial setting to the metadata.

More preferably, the conversion means converts bitmap data generated by a renderer into the print data in accordance with the overall setting and the partial setting while preferentially applying the partial setting to the bitmap data.

Alternatively, the present invention has a constitution as described below.

That is, a printing control apparatus of the present invention is a printing control apparatus for converting inputted drawing data into a print data which a printing apparatus can print and transferring the print data to the printing apparatus, the printing control apparatus including:

means which determines an overall setting which is a print setting to be applied to the entire drawing data;

means which records the overall setting determined by the overall setting determination means in a setting table for managing settings;

means which determines a partial setting which is a setting to be applied only to a part of pages in the case in which the drawing data extends over a plurality of pages;

means which records the partial setting determined by the partial setting determination means in the setting table; and

means which determines a setting to be used for each page of interest from the setting table and generates print data based upon the determined setting.

Alternatively, the present invention is a printing system which connects any one of the printing control apparatuses described above with a printing apparatus and print-outputs print data, which is converted by the printing control apparatus, with the printing apparatus.

Alternatively, the present invention is a computer program for realizing any one of the printing control apparatuses described above with a computer.

Alternatively, the present invention is a computer readable recording medium which has the computer program recorded therein.

According to the above-described constitutions, it is made possible to perform a setting for each page divided arbitrarily in print setting for a printer driver rather than applying the same print setting to an entire document, and the driver manages these settings as a table to automatically use a setting of a corresponding page at the time of printing. Consequently, it becomes possible to use a plurality of print settings in one print job. In addition, in a print setting, a set value of each item set on a usual overall setting screen becomes a default set value of each item in performing a print setting designating a page to which the print setting is applied. Consequently, it becomes possible to perform printing with a high degree of freedom with a simple manipulation.

Other features and advantageous of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a block diagram showing a structure of a print system of a first embodiment;

FIG. 2 is a flowchart showing a print setting procedure in first and second embodiments;

FIG. 3 is a flowchart showing a flow of processing up to execution of printing in the first embodiment;

FIG. 4 is a block diagram showing a structure of a print system in the second embodiment;

FIG. 5 is a flowchart showing a flow of processing up to execution of printing in the second embodiment;

FIG. 6 is a block diagram showing an entire setting screen in the first and second embodiments;

FIG. 7 is a block diagram showing a page designation setting screen in the first and second embodiments;

FIG. 8 is a block diagram showing a setting table in the first and second embodiments; and

FIG. 9 is a block diagram of a computer and a printer.

### DETAILED DESCRIPTION OF THE PREFERRED EMBODIMENTS

Embodiments of the present invention will be hereinafter described in detail with reference to the accompanying drawings.

[First Embodiment]

<Description of an Entire System>

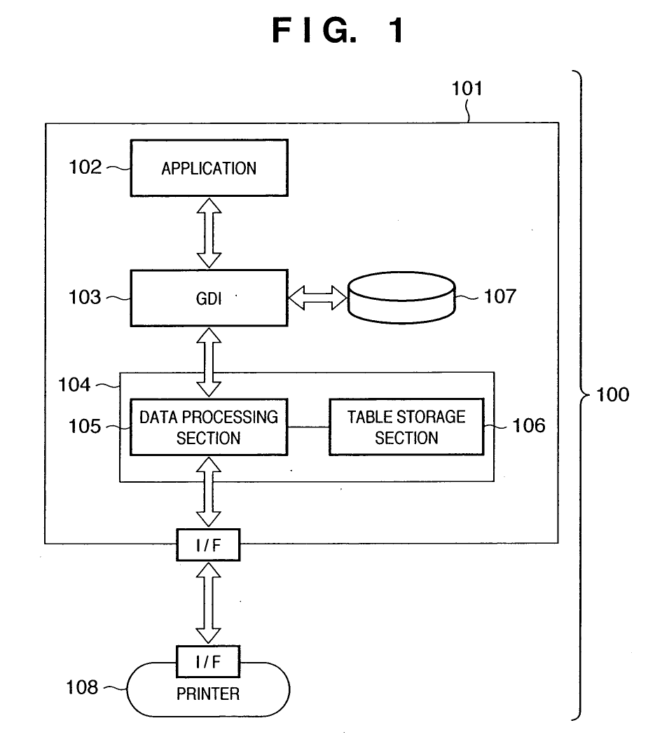

FIG. 1 is a block diagram showing an example of a structure of a print system 100 in a first embodiment of the present invention.

Application software 102 is software running on an operating system (hereinafter referred to as OS), which is basic software for a host computer 101, and has a function of printing prepared data. As the application software 102, word processor software for document preparation, drawing preparation software, presentation software, and the like are conceivable.

A GDI (Graphic Device Interface) 103 is an output module peculiar to the OS and is a subsystem (group of basic functions) of the OS which controls processing of image information. An application is capable of outputting drawing information without depending upon a device by using the basic functions. This GDI 103 dynamically links and uses device drivers of designated devices such as a display and a printer to thereby perform output processing with respect to the respective devices. Therefore, in outputting data to the printer, the GDI 103 outputs the data to a printer driver. Data to be outputted by the GDI 103 is stored in a spooler 107 as required.

A printer driver 104 converts data into a data format which can be printed in a predetermined printer, by a call from GDI 103 and outputs the data to the printer. In that case, the printer driver 104 has a function of displaying and controlling a print setting screen (UI) for determining in what kind of setting print data is generated, and generates the print data based upon a setting designated by this UI.

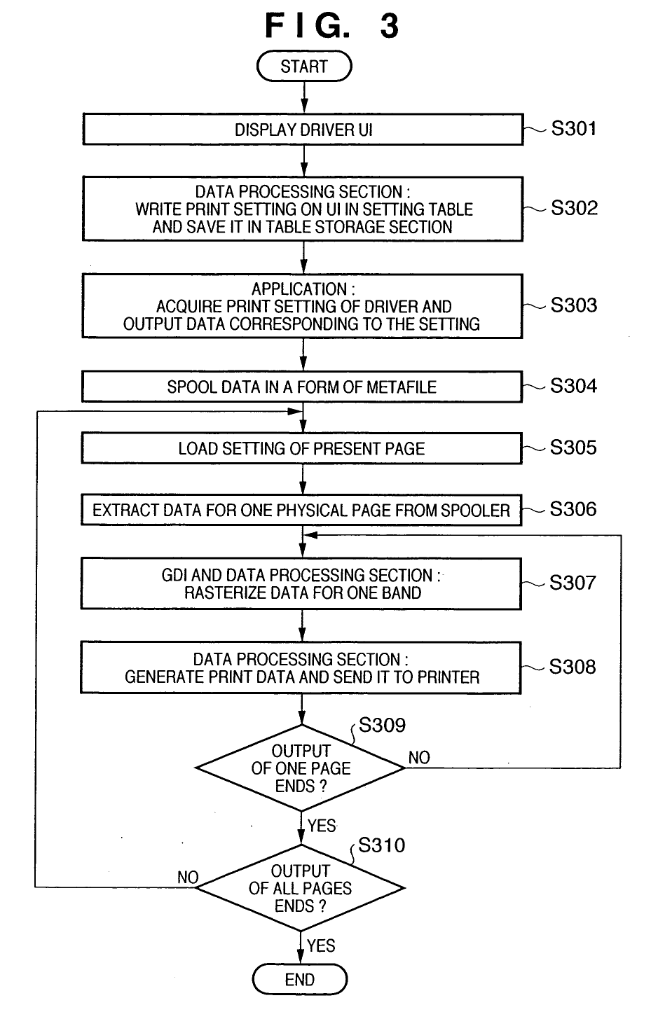

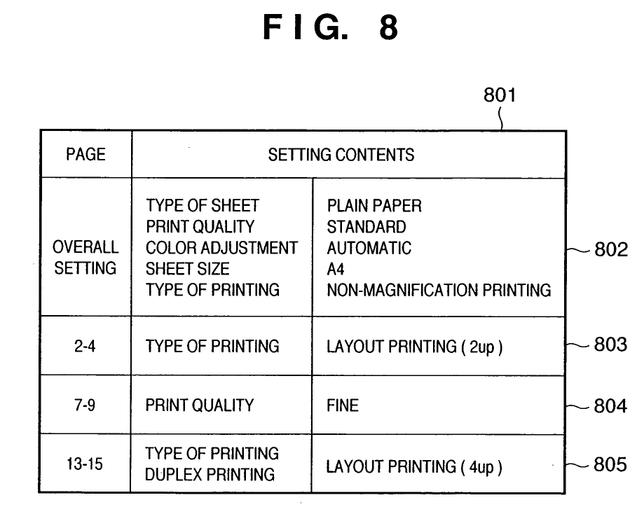

The printer driver 104 of this embodiment includes a data processing section 105 and a table storage section 106. The data processing section 105 performs entire processing such as controlling the UI and receiving data from the GDI 103 to generate print data based upon the setting of the UI. The table storage section 106 is a storage area for storing a setting table for managing print setting performed on the UI displayed by the data processing section 105. The data processing section 105 stores print setting information in the table storage section 106 as a setting table as shown in FIG. 8. In generating print data, the data processing section 105 loads a setting of a necessary page from the setting table in the table storage section 106 and performs generation of print data corresponding to the setting. Note that, as the setting table to be stored in the table storage section 106, there are a default setting table which saves a default setting given as a standard value in advance for each model of a printer and a normal setting table which saves an overall setting and a setting by page, which are changed by a user in a procedure of FIG. 3 described later based upon the default setting. Initially, contents of the default setting table are copied in the normal setting table as overall setting.

Note that, although a storage area for storing a setting table is provided in the printer driver 104 in a form of a table storage section here, a place for storing a table may not be in the printer driver 104. For example, it is also possible that a setting table is stored in another storage area in the host computer 101, and the printer driver 104 loads the setting table according to circumstances.

<Description of Structures of a Computer and a Printer>

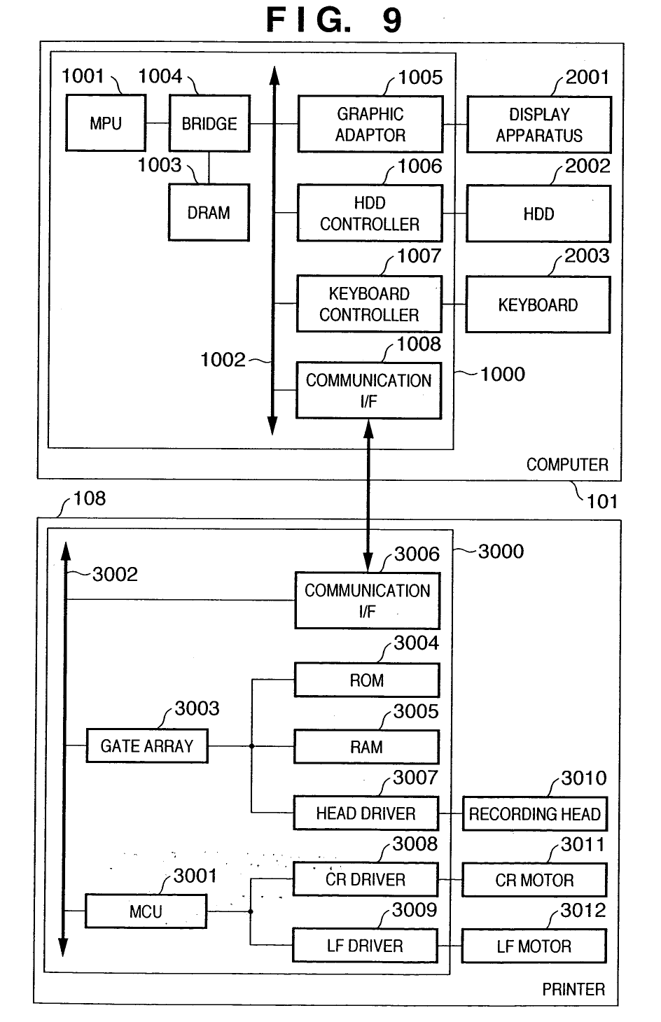

Next, hardware structures of the computer 101 and a printer 108 will be described with reference to FIG. 9.

As shown in FIG. 9, the computer 101 includes a processing unit 1000 and peripheral equipment. In addition, the printer 108 includes a recording head 3010, drive units such as a carrier (CR) motor 3011 which drives a carrier for conveying the recording head 3010 and a conveyance motor 3012 which conveys a sheet, and a control circuit unit 3000.

The processing unit 1000 of the computer 101 includes an MPU 1001, a bus 1002, a DRAM 1003, a bridge 1004, and a graphic adaptor 1005. The MPU 1001 manages overall control of a host apparatus in accordance with a control program. The bus 1002 connects system components with each other. The DRAM 1003 temporarily stores a program, data, and the like to be executed by the MPU 1001. The bridge 1004 connects a system bus, a memory bus, and the MPU 1001. The graphic adaptor 1005 is provided with, for example, a control function for displaying graphic information on a display apparatus 2001 such as a CRT.

In addition, the processing unit 1000 includes an HDD controller 1006, a keyboard controller 1007, and a communication I/F 1008. The HDD controller 1006 controls an interface with an HDD device 2002. The keyboard controller 1007 controls an interface with a keyboard 2003. The communication I/F 1008 is a parallel interface which controls communication with the printer 108 in accordance with the IEEE1284 standard.

Further, the display apparatus 2001 (in this example, CRT) which shows graphic information or the like to an operator is connected to the processing unit 1000 via the graphic adaptor 1005. Moreover, a hard disk drive (HDD) device 2002, which is a large capacity storage device having programs and data stored therein, and a keyboard 2003 are connected to the processing unit 1000 via a controller.

On the other hand, the printer 108 is a serial printer of an ink-jet system in this embodiment. The control circuit unit 3000 of the printer 108 includes an MCU 3001, a system bus 3002, and a gate array (G.A.) 3003. The MCU 3001 is provided with both a control program execution function and a peripheral equipment control function and controls overall control of the printer 108. The system bus 3002 connects components in a control circuit unit. The gate array (G.A.) 3003 includes a mechanism for supply of recording data to the recording head 3010, memory address decoding, generation of a control pulse to a carrier motor, and the like as a control circuit.

In addition, the control circuit unit 3000 includes a ROM 3004, a DRAM 3005, a communication I/F 3006, and a head driver 3007. The ROM 3004 stores a control program to be executed by the MCU 3001, host printing information, and the like. The DRAM 3005 saves various data (image recording information, recording data to be supplied to a head, etc.). The communication I/F 3006 is a parallel interface which controls communication with a host apparatus 51 in accordance with the IEEE 1284 standard. The head driver 3007 converts a head recording signal outputted from the gate array 3003 into an electric signal for driving the recording head 3010.

Moreover, the control circuit unit 3000 includes a CR motor driver 3008 and an LF motor driver 3009. The CR motor driver 3008 converts a carrier motor control pulse outputted from the gate array 3003 into an electric signal for actually driving the carrier (CR) motor 3011. The LF motor driver 3009 converts a conveyance motor control pulse outputted from the MCU 3001 into an electric signal for actually driving the conveyance motor.

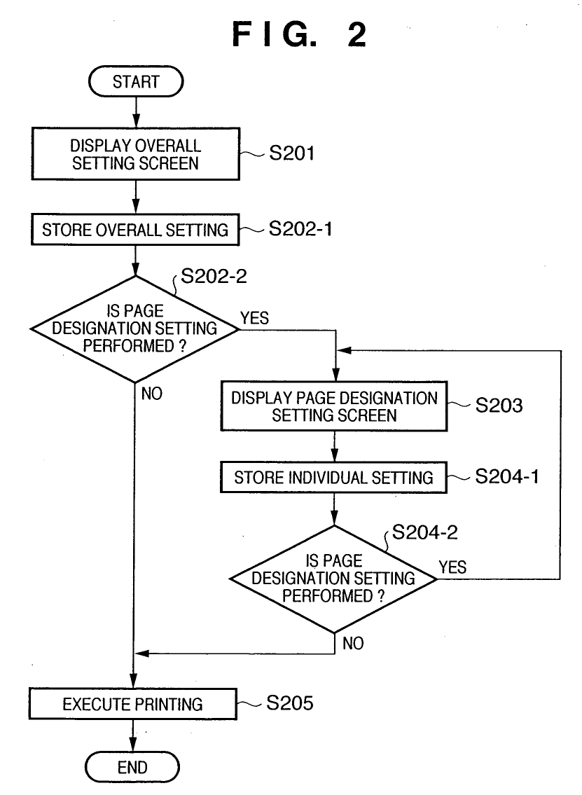

Each block of the system shown in FIG. 1 is realized by executing programs such as programs for procedures of FIGS. 2, 3, and 5 described later in the computer of FIG. 9.

<Description of a Flow of Processing>

FIG. 2 is a flowchart showing a flow of processing in the print system 100 of this embodiment. An outline of print processing in this system will be described in an example using document preparation software as the application software 101.

<Print Setting Method>

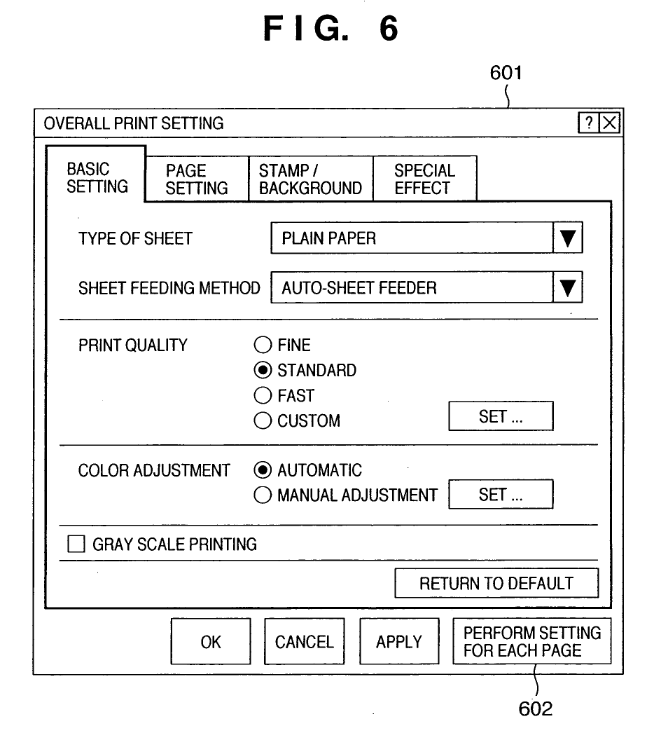

When a user selects a printer to be used in a printing menu of the application 102 to display a print setting screen of the printer driver 104, a setting screen as shown in FIG. 6 is displayed (S201). The setting screen displayed here is a screen for performing a basic setting to be applied to an entire document (overall setting) (hereinafter referred to as overall setting screen), on which the above-described various print setting such as a setting for image processing and a page layout can be performed.

FIG. 6 is a diagram showing an overall setting screen 601 in this embodiment. Contents set by the user here using a pointing device such as a mouse are deemed to be an overall setting which is a basic setting to be applied to the entire document. The contents are written in a setting table 801 as shown in FIG. 8 as the overall setting and stored in the table storage section 106 (S202-1).

In the case in which the entire document is printed in the same setting, the user performs only a setting on the overall setting screen to end the print setting, and press a not-shown print execution button displayed in the print menu of the application 102 to execute printing. This designation is judged by step S202-2. If a setting for each page (page designation setting) is not performed, the print setting is finished. If the print execution button is pressed, printing is executed in accordance with the designated setting (S205). More specifically, the printer driver 104 is called to a RAM by a call from the GDI 103, and converts a drawing output (called a DDI function) from the GDI 103 into print data of a data format, which can be printed by a predetermined printer, and outputs the print data to the spooler of the OS to thereby output the print data to the printer.

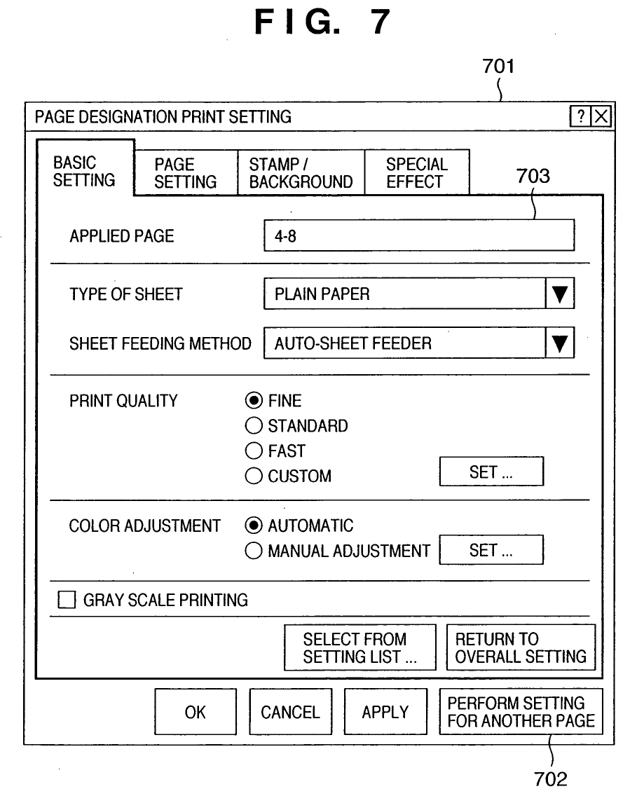

On the other hand, in the case in which a setting is switched in the middle of a document to perform printing in a different setting for each page, a page designation setting is performed after the overall setting is performed. The overall setting screen 601 is provided with an individual setting button 602 serving as an option for changing a setting for each page to perform printing. When the individual setting button 602 is pressed, it is judged in step S202-2 that the individual setting button 602 is pressed, and page designation setting screen 701 as shown in FIG. 7 is displayed by the printer driver 104 (S203).

In addition to each setting item in the overall print setting screen 601, the page designation setting screen 701 is provided with a box 703 for designating a page to which an individual setting is applied. A setting performed on this screen is applied to only a range designated here. A single page or a range of pages or a group of pages to which an identical setting is applied can be designated. In addition, an initial value of each setting item of the page designation setting screen 701 is a value of the overall setting which is set on the overall setting screen and stored in the setting table 801 in S202. In the page designation setting screen 701, a designated page can be printed in a setting different from the overall setting by changing only an item desired to be changed from the set value of the overall setting. In this case, only items different from the overall setting are written in the setting table by the printer driver 104 as shown in FIG. 8 as a setting of the designated page (S204-1).

Moreover, in the case in which the user wishes to print other pages of the document in the setting different from the basic setting, the user presses the individual setting button 702 provided in the page designation setting screen 701, whereby the page designation setting screen 701 for performing settings for other pages individually is displayed anew. It is judged in step S204-2 that the individual setting button 702 is pressed. The page designation setting screen 701 displayed here is provided with the same appearance and functions as those of the screen displayed by pressing the individual designation button 602 on the overall setting screen 601. Therefore, an initial value of each setting item is a set value of the overall setting, and a set value different from the overall setting is applied only to the changed items. Only items having a different set value from the overall setting are stored in the setting table in the same manner.

The page designation setting of S203 to S204-2 is repeated until the user does not wish to change a setting for any page. When all the settings are completed, the user presses the print execution button to execute printing, whereby printing in the designated settings is executed (S205).

The setting table 801 of FIG. 8 shows an example in which a print setting designating a page is registered with respect to an overall setting 802 serving as a basic setting. In the setting table shown in FIG. 8, a page designation setting 803 with a type of printing changed from “non-magnification printing” of the overall setting to “layout printing (2-up)” is applied to pages 2 to 4, a page designation setting 804 with a print quality changed from “standard” of the overall setting to “fine” is applied to pages 7 to 9, and a page designation setting 805 with a type of printing changed from “non-magnification printing” of the overall setting to “layout printing (4-up)” and duplex printing changed from “OFF (not designated)” of the overall setting to “ON” is applied to pages 13 to 15. In this way, the overall setting and the page designation setting of pages with settings changed with respect to the overall setting are stored in the setting table.

<Processing of a System Up to Execution of Printing>

FIG. 3 is a flowchart showing processing from designation of printing in an application to the end of the printing.

When a print dialog is displayed in the application 102 and a printer to be used is selected, the data processing section 105 displays a print setting screen (S301). When detailed print setting is performed in the procedure of FIG. 3 on the print setting screen, the data processing section 105 stores the overall setting and the page designation setting as the setting table as shown in FIG. 8. Then, when execution of printing is designated by pressing a print button in the application, the data processing section 105 stores a decided setting table in the table storage section 106 (S302).

On the other hand, the application 102 requests a setting at the time of execution of printing from the driver 104. In response to this request, the data processing section 105 returns the set value of the overall setting to the application from the setting table stored in the table storage section 106. Then, the application calls the GDI function to thereby output data based upon the print setting acquired from the driver 104 (S303). Note that, in the following description, the expression that the application calls the GDI 103 to output data may be represented as the application outputs data.

Here, concerning items for which a different setting can be used in the middle for each page, the set value of the overall setting given to the application 102 by the driver 104 is the default set value, that is, the contents of the default setting table. This is because it is preferable that an output size and a layout of drawing data to be outputted from the application 102 is the default set value in order to change a setting in the middle of a document to print the document after the application 102 has finished output. For example, concerning a resolution and a page layout, it is likely that magnification/reduction processing is performed on a driver side for N-up printing or the like. Taking this into account, an output from the application 102 is required to be data based upon the default set value of the driver. In addition, the data processing section 105 switches parameters or the like to be used for color processing with reference to the setting table in the processing after the end of output of the application 102 to thereby realize printing in a different setting. Therefore, the print setting given to the application 102 is the default value of the driver, and the driver performs processing corresponding to the setting table in a later step with respect to data outputted by the application 102 in the default set value.

When the application 102 has finished the output of data, the data processing section 105 of the driver spools data, which has been outputted in a form of a metafile not having setting information, in the spooler 107 by an amount equivalent to all pages while checking various settings at the time when the application has outputted the data (S304). The application is released at this point. This metafile is, so to speak, an intermediate data of a format which can be interpreted by any printer and other output devices and does not depend upon a device. The metafile is converted into a format which can be processed in the printer 108 by the printer driver 104. Note that, taking Windows OS of Microsoft Corporation as an example, it is desirable to use an EMF file.

Here, the processing for spooling an output from the application as a metafile may be performed by the printer driver in its inside or may be realized by a subsystem of the OS. In addition, in the case in which the printer driver always processes the output in its inside, the printer driver 104 may spool the output as a spool file of an original format in the inside without using the above-described metafile. In that case, the spool file 107 is accessed from the printer driver 104.

<Processing After Execution of Printing>

When the spool ends, the data processing section 105 refers to the setting table stored in the table storage section 106 to load a setting to be used for printing of a page of interest with a first page as a top page number of interest (S305). Therefore, the data processing section 105 retrieves through a “page” column of the setting table of FIG. 8 and, if a page of interest, for example, a first page, is included in a page designation column, the data processing section 105 can judge that an individual setting for the page of interest is made. If the individual setting is made, the data processing section 105 loads the overall setting and the individual setting for the page of interest, that is, the first page in this case, to a memory referred to by the printer driver 104. In that case, the data processing section 105 uses a set value of the individual setting as a print setting of the page of interest for items described in the individual setting, and uses a set value of the overall setting as a print setting of the page of interest for the other items. In the case in which there is no setting of the page of interest in the page designation setting, in order to perform printing based upon the overall setting, the data processing section 105 loads the set value of the overall setting to use it for all the items. Note that, although the setting for the page of interest in the setting table is described here as being downloaded every time the processing of the page of interest is performed, the printer driver 104 may directly access the table storage section 106 to refer to a set value for the page of interest.

Since the generation of print data repeats processing for each physical page, in performing the N-up printing in which a plurality of logical pages (data by a unit of page prepared by the application) are arranged with respect to one physical page (one side of a printing sheet), the logical pages forming one physical page are collectively processed. Therefore, the data processing section 105 checks a set value for the page layout in the print setting for the page of interest and loads a metafile for logical pages, which are necessary for forming one physical page, from the spooler. If the 2-up printing is set as the print setting for the page of interest, the data processing section 105 checks a setting of the next page of the present page of interest and, if the 2-up printing is also set in the next page, loads a metafile for continuous two logical pages from the spooler. Then, the data processing section 105 applies processing for generating print data to the loaded metafile for two pages such that the metafile is arranged on the physical page in the 2-up layout. In the case in which the print data is outputted to a PDL (Page Description Language) printer, the data processing section 105 performs magnification/reduction processing of drawing contents and processing for arranging drawing contents corresponding to a resolution. In addition, in the case in which the print data is outputted to a raster printer (an ink-jet printer mainly uses this format), the data processing section 105 performs rasterize processing in the 2-up layout. Thereafter, the data processing section 105 performs image processing such as color correction according to print setting of a print quality and color adjustment, generates print data, and output the print data to a print spooler (not shown) of the OS in order to output it to the printer. In this case, a page of interest to be processed next changes to a second page. In this way, since the rasterize processing is performed by a unit of physical page, if the N-up print setting is made, logical pages equivalent to N pages are collectively processed. Therefore, in the case in which continuous logical pages in which the N-up printing is set are less than N pages, the N-up printing is performed only for the pages in which the N-up printing is set, and the remaining pages are printed on the next physical page.

In addition, in the case in which logical pages with different settings of a type of a sheet or the like cannot be printed on an identical physical page, processing is performed such that these pages are printed on the next physical page.

Note that, in this embodiment, the description is made with the raster printer for dividing one page by a predetermined band width to perform processing for one page, so-called banding processing, as an example. Therefore, when the rasterize data for one band ends and band data is prepared (S307), the printer driver 104 performs processing such as converting raster data from an RGB color system into a CMYK color system to generate print data. At this point, in the case in which the duplex printing is set, the printer driver 104 generates print data by adding a present necessary command such as adding a command instructing the duplex printing and a command indicating that data to be sent is a front side or a back side of a sheet at the time of the duplex printing. The print data by a unit of band generated in this way is sent to the printer 108 (S308). The data processing section 105 repeats this processing until the processing for one physical page ends (S309) to end the processing for one page.

The data processing section 105 repeats the processing by a unit of physical page for all the spooled pages to thereby ends printing of all the pages (S310).

According to the above-mentioned processing, print setting can be performed for each page. Then, print setting to be used can be automatically switched, for each page designated in one print jog, to print setting corresponding to the page according to the set print setting by a unit of page to perform printing. Note that, as items which can be set for each page, for example, there are a type of a sheet (distinction of plain paper, special purpose paper, and a film for OHP, etc.), a print quality (algorithm of binarization processing, resolution, etc.), color adjustment (presence or absence of automatic adjustment by a printer driver, etc.), a page layout (N-up designation, etc.), contents and presence and absence of a watermark, and contents and presence and absence of a header/footer.

Note that, in this embodiment, bitmap data is described as being generated by a computer. However, a data format which can be processed by a printer is not always limited to a bitmap format. In the case in which a printer is provided with an interpreter with a fixed PDL, print data of a format described in the PDL may be generated from a metafile. Even in such a case, print data is generated with reference to an overall setting for each page and an individual setting for the page and in accordance with these settings.

[Second Embodiment]

<Description of an Entire System>

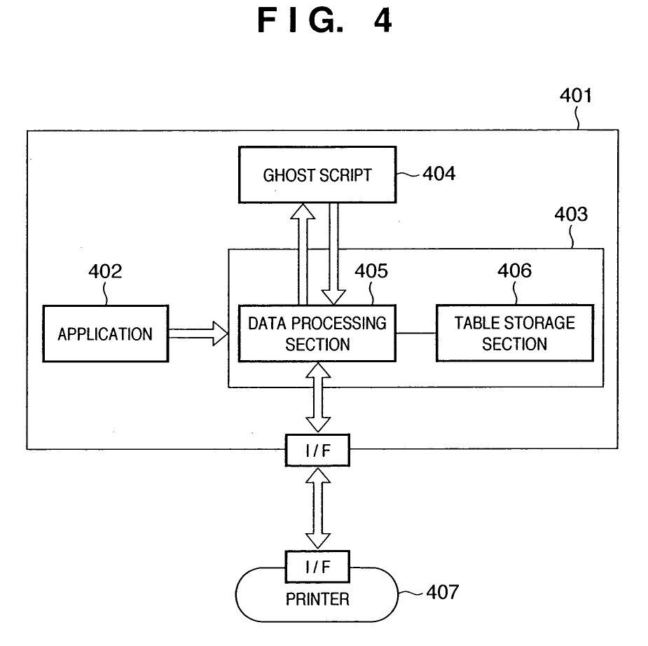

FIG. 4 is a block diagram showing an example of a structure of a print system in a second embodiment of the present invention. In this embodiment, the system is constituted by using an UNIX (registered trademark) OS such as Linux as an OS for a host computer 401 for performing printing.

In the case in which printing is performed on the UNIX OS such as Linux, in an environment in which a system such as X Window can be used, there are two methods, namely, printing through an application which prints data prepared in the application using a GUI and command line printing which performs printing directly designating an image file from a command line without using a GUI. In the printing from the application, when data is prepared on the application and printing is instructed, the application converts the data into a format such as PostScript (registered trademark) to output the data. In the case in which a PostScript (PS) printer which can print PostScript data is used, it is possible to perform printing by outputting PostScript data outputted from the application to the printer. However, in an ink-jet printer which cannot print PostScript data, processing for converting PostScript data outputted from the application into print data to be sent to the printer is required. In general, PostScript data outputted from the application is first inputted to a renderer such as GhostScript (registered trademark) and converted into bitmap data to be outputted. Then, a printer driver converts the outputted bitmap data into print data which the printer can interpret and sends the print data to the printer, whereby printing is performed. In this way, in the UNIX OS, the application outputs a PostScript file, the renderer converts the PostScript file into bitmap data, and the driver converts the bitmap data into print data. Thus, printing is performed in a form in which each program sequentially converts data.

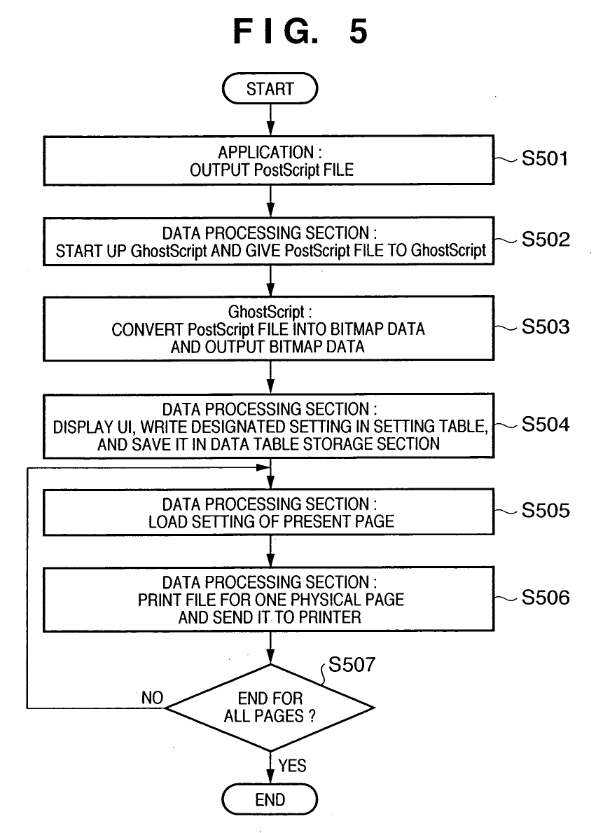

In the print system in this embodiment, as shown in FIG. 4, GhostScript is used as the renderer to perform the printing from an application. The print system in this embodiment will be hereinafter described in detail with reference to FIGS. 4 and 5.

<Structure of a System>

In FIG. 4, it is assumed that a host computer 401 uses Linux which is a UNIX OS, and uses an X Window system on Linux to perform printing of data prepared in an application 402. The application 402 is a document preparation program or an image edition program running on Linux, and has a function of printing prepared data and a function of outputting data as a PostScript file at the time of printing.

A printer driver 403 is a printer driver for performing processing such as starting up a GhostScript 404 in order to convert PostScript data outputted by the application 402 into print data and converting bitmap data outputted by the GhostScript 404 into print data. The printer driver 403 includes a data processing section 405 and a table storage section 406. The data processing section 405 perform the processing such as control of the UI, startup of the GhostScript 404, and data conversion. Moreover, the data control section 405 stores a setting made on the UI controlled by the data control section 405 in the table storage section 406 as a setting table as shown in FIG. 8. In generating print data, the data control section 405 loads a setting of a necessary page from the setting table to generate print data corresponding to the setting.

Note that, although a storage area for storing the setting table of FIG. 8 in the printer driver 403 in a form of the table storage section 406 here as in the first embodiment, a place for storing the setting table is not limited to the inside of the printer driver 403. For example, it is also possible to store the setting table in another storage area in the host computer 401 and the printer driver 403 loads the setting table according to circumstances.

<Processing of the System Up to Execution of Printing>

FIG. 5 is a flowchart showing processing in performing printing in the print system shown in FIG. 4.

Setting of an output size or the like can be performed in a dialog which is displayed in printing data edited on the application 402. However, the “output size” which is set here is a size of one page of a PostScript file outputted from the application and does not indicate a size of a sheet on which data is actually printed. Similarly, all settings which can be designated in other applications are setting with respect to PostScript data outputted by the application 402. Then, when printing is executed in the print dialog of the application designating a printer to be used for printing, the application outputs all pages as the PostScript file in an output size designated in the print dialog of its own (S501).

In the printer driver 403, the data processing section 405 starts up the GhostScript 404 in order to convert the PostScript file outputted from the application 402 into bitmap data and give it the PostScript file (S502). In this case, the data processing section 405 starts up the GhostScript 404 designating a format of data to be outputted and a size of one page. For example, the data processing section 405 make a designation such as outputting data in a bmp file of A4 size.

The GhostScript 404 renders inputted PostScript data into bitmap data of a form designated by the printer driver 403 and outputs the bitmap data (S503).

Upon receiving the bitmap data outputted from the GhostScript 404, the data processing section 405 displays a print setting screen (UI) for performing print setting. A procedure of the print setting is the same as that in the first embodiment and is performed according to the procedure shown in FIG. 2. Therefore, a UI to be displayed first is a UI for performing the overall setting as shown in FIG. 6. When the individual setting button 602 is pressed on this UI, a page designation setting screen 701 as shown in FIG. 7 is displayed. Then, the data processing section 405 performs the individual setting for each page as required and ends the print setting.

In this case, the data processing section 405 writes the overall setting and the page designation setting in the setting table, respectively. When all the settings are finished and execution of printing is designated by pressing the print button, the data processing section 405 stores the setting table, in which setting of each page is written, in the table storage section 406 (S504).

Then, the data processing section 405 loads a setting of a present page one by one (S505), applies predetermined color processing or conversion from RGB to CMYK to bitmap data, adds a print command to the bitmap data to generate print data, and outputs the print data to the printer (S506). In this case, as in the first embodiment, since the processing of generating print data by a unit of physical page and sending the print data to the printer is repeated, logical pages constituting one physical page are collectively processed in performing the N-up printing. When this processing is repeated to finish outputting the print data with respect to all the bitmap data (for all the pages) outputted by the GhostScript 404, the data processing section 405 ends the processing (S507).

Processing in which the data processing section 405 generates print data from bitmap data in accordance with contents of the setting table in S505 to S506 will be hereinafter described in detail.

<Print Data Generation in the Data Processing Section>

The data processing section 405 loads a setting to be used for printing of a page of interest with reference to the setting table stored in the table storage section 406. Here, a description is made assuming that the page of interest is a first page. In this case, if the first page is individually set in page designation, the data processing section 405 loads the overall setting and the individual setting for the page of interest, and uses a set value of the individual setting as a print setting of the page of interest for an item described in the individual setting and uses a set value of the overall setting as a print setting of the page of interest for the other items. If there is no setting of the first page in the page designation setting, since printing is performed based upon the overall setting, the data processing section 405 loads the set value of the overall setting and uses the set value.

Since generation of print data repeats processing for each physical page, in performing the N-up printing in which a plurality of logical pages are arranged for one physical page, the data processing section 405 processes logical pages forming one physical page collectively. Therefore, the data processing section 405 checks a set value for a page layout among the settings for a present page of interest and reads bitmap data for logical pages required for forming one physical page. For example, when the 2-up printing is set, the data processing section 405 reads bitmap data for two logical pages. Then, the data processing section 405 performs the magnification/reduction processing and layout change based upon an applied print setting to perform rasterize processing again. For example, if the 2-up printing is set, the data processing section 405 performs processing for reducing read two logical pages and laying it out as one physical page.

Then, the data processing section 405 performs processing such as color correction according to the print setting and conversion from RGB to CMYK, generates a print file, and outputs the print file to the printer 407. If the duplex printing is set, the data processing section 405 generates print data by adding a command necessary for a present print setting such as adding a command instructing the duplex printing and a command indicating a front or a back of a sheet at the time of duplex printing.

The data processing section 405 repeats this processing until it is finished for all the pages, and ends the printing.

In the above-described flow, a plurality of print settings can be performed for each page to perform printing by automatically switching to use the set print setting in one job.

In this way, according to the printer driver realizing the procedures of the first and second embodiments, it becomes possible to perform a print setting for an entire document and a print setting for each page. Then, the printer driver manages these settings performed on the printer driver UI as a table, whereby it becomes possible to perform printing while switching to use various settings in one print job.

In addition, in the print setting, a set value which is set on a usual overall setting screen becomes a default set value at the time of page designation setting, whereby it becomes possible to perform a printing with a high degree of freedom with a simple manipulation.

In particular, in this embodiment, it becomes possible to generate bitmap data as print data, which is sent to a printer, in a host computer according to a print setting for each page. Consequently, the present invention is particularly effective in the case in which a printer to be used is a printer in which a processible data format is often limited to a bitmap data format as in an ink-jet printer or the like.

Note that the present invention may be applied to a system constituted by a plurality of apparatuses (e.g., a host computer, an interface device, a reader, a printer, etc.) or may be applied to an apparatus constituted by one apparatus (e.g., a copying machine, a facsimile apparatus, etc.).

In addition, the object of the present invention is also attained by supplying a storage medium (or a recording medium) having recorded therein software realizing the functions of the embodiments to a system or an apparatus, and a computer (or a CPU or an MPU) of the system or the apparatus reading out to execute a program code stored in the storage medium.

In this case, the program code itself read out from the storage medium realizes the functions of the embodiments, and the program code itself and the storage medium having the program code stored therein constitute the present invention.

Further, the present invention includes not only the case in which the functions of the embodiments are realized by the computer executing the read out program code but also the case in which an operating system (OS) or the like running on the computer performs a part of or entire actual processing, and the functions of the embodiments are realized by the processing.

Moreover, the present invention also includes the case in which a program code read out from a storage medium is written in a memory provided in a function extended card inserted in a computer or a function extended unit connected to the computer, and then, based upon an instruction of the program code, a CPU or the like provided in the function extended card or the function extended unit performs a part of or entire actual processing, and the functions of the embodiments are realized by the processing.

As described above, according to the present invention, there is an effect that it becomes possible to change a setting for each page divided arbitrarily to cause a printer to perform printing rather than applying the same print setting to an entire document.

In addition, a printer driver manages print settings as a table, whereby it becomes possible to perform printing while switching to use various settings in one job.

Further, in a print setting, a set value which is set on an overall setting screen becomes a default set value at the time of page designation setting, whereby manipulation of setting is facilitated, and it becomes possible to perform printing with a high degree of freedom with a simple manipulation.

As many apparently widely different embodiments of the present invention can be made without departing from the spirit and scope thereof, it is to be understood that the invention is not limited to the specific embodiments thereof except as defined in the appended claims.

What is claimed is:

1. A printing control method of converting data into print data which a printing apparatus can process, said printing control method comprising:
a setting step of setting an overall setting to be applied to the entire print data and a partial setting to be applied to a designated page in generating the print data; and
a conversion step of converting the data into the print data in accordance with the overall setting and the partial setting while preferentially applying the partial setting set by said setting step.

2. The printing control method according to claim 1,
wherein said setting step has a page designation step of designating a page to which the partial setting is applied and, in said conversion step, the overall setting is applied to items other than items to which the partial setting is applied.

3. The printing control method according to claim 1,
wherein said conversion step converts metadata generated by an operating system into the print data in accordance with the overall setting and the partial setting while preferentially applying the partial setting to the metadata.

4. The printing control method according to claim 1,
wherein said conversion step converts bitmap data generated by a renderer into the print data in accordance with the overall setting and the partial setting while preferentially applying the partial setting to the bitmap data.

5. The printing control method according to claim 1,
wherein the print data is bitmap data.

6. A printing control method of converting inputted drawing data into a print data which a printing apparatus can print and transferring the print data to the printing apparatus, said printing control method comprising:
a first determination step of determining an overall setting which is a print setting to be applied to the entire drawing data;
a step of recording the overall setting determined in said first determination step in a setting table for managing settings;
a second determination step of determining a partial setting which is a setting to be applied only to a part of pages in the case in which the drawing data extends over a plurality of pages;
a step of recording the partial setting determined in said second determination step in the setting table; and
a step of determining a setting to be used for each page of interest from the setting table and generating print data based upon the determined setting.

7. The printing control apparatus for converting data into print data which a printing apparatus can process, said printing control apparatus comprising:
a setting unit which sets an overall setting to be applied to the entire print data and a partial setting to be applied to a designated page in generating the print data; and
a converter which converts the data into the print data in accordance with the overall setting and the partial setting while preferentially applying the partial setting set by said setting unit.

8. The printing control apparatus according to claim 7,
wherein said converter converts metadata generated by an operating system into the print data in accordance with the overall setting and the partial setting while preferentially applying the partial setting to the metadata.

9. The printing control apparatus according to claim 7,
wherein said converter converts bitmap data generated by a renderer into the print data in accordance with the overall setting and the partial setting while preferentially applying the partial setting to the bitmap data.

10. A printing control apparatus for converting inputted drawing data into a print data which a printing apparatus can print and transferring the print data to the printing apparatus, said printing control apparatus comprising:
a first determination unit which determines an overall setting which is a print setting to be applied to the entire drawing data;
a first recorder which records the overall setting determined in said first determination unit in a setting table for managing settings;
a second determination unit which determines a partial setting which is a setting to be applied only to a part of pages in the case in which the drawing data extends over a plurality of pages;
a second recorder which records the partial setting determined in said second determination unit in the setting table; and
a generator which determines a setting to be used for each page of interest from the setting table and generates print data based upon the determined setting.

11. A printing system comprising:
a printing control apparatus for converting drawing data into a print data which a printing apparatus can process, comprising: a setting unit which sets an overall setting to be applied to the entire print data and a partial setting to be applied to a designated page in generating the print data; and a converter which converts the data into the print data in accordance with the overall setting and the partial setting while preferentially applying the partial setting set by said setting unit; and
a printer which is connected to said printing control apparatus and performs print processing in accordance with the print data.

12. A printing system comprising:
a printing control apparatus for converting inputted drawing data into a print data which a printing apparatus can print and sending the print data to the printing apparatus, comprising: a first determination unit which determines an overall setting which is a print setting to be applied to the entire drawing data;
a first recorder which records the overall setting determined in said first determination unit in a setting table for managing settings;
a second determination unit which determines a partial setting which is a setting to be applied only to a part of pages in the case in which the drawing data extends over a plurality of pages;
a second recorder which records the partial setting determined in said second determination unit in the setting table; and
a generator which determines a setting to be used for each page of interest from the setting table and generates print data based upon the determined setting; and
a printing control apparatus for converting inputted drawing data into a print data which a printing apparatus can print and transferring the print data to the printing apparatus; and
a printer which is connected to said printing control apparatus and performs print processing in accordance with the print data.

13. A computer program product recorded in a computer readable medium, comprising:
a setting process procedure code which sets an overall setting to be applied to the entire print data and a partial setting to be applied to a designated page in generating the print data; and
a conversion process procedure code which converts the data into the print data in accordance with the overall setting and the partial setting while preferentially applying the partial setting set by said setting process procedure code.

14. A computer program product recorded in a computer readable medium, comprising:
a first determination process procedure code which determines an overall setting which is a print setting to be applied to the entire drawing data;
a process procedure code which records the overall setting determined in said first determination process procedure code in a setting table for managing settings;
a second determination process procedure code which determines a partial setting which is a setting to be applied only to a part of pages in the case in which the drawing data extends over a plurality of pages;
a process procedure code which records the partial setting determined in said second determination process procedure code in the setting table; and
a process procedure code which determines a setting to be used for each page of interest from the setting table and generates print data based upon the determined setting.
